(19) United States
(12) Patent Application Publication
(10) Pub. No.: US 2013/0256967 A1
(43) Pub. Date: Oct. 3, 2013

(54) MANAGING ENERGY TRANSMISSION

(71) Applicant: TERADYNE, INC., North Reading, MA (US)

(72) Inventor: Valquirio N. Carvalho, Lowell, MA (US)

(73) Assignee: TERADYNE, INC., North Reading, MA (US)

(21) Appl. No.: 13/786,937

(22) Filed: Mar. 6, 2013

Related U.S. Application Data
(60) Provisional application No. 61/616,672, filed on Mar. 28, 2012.

(51) Int. Cl. B23Q 1/03

(52) U.S. Cl. CPC B23Q 1/032
USPC 269/315

(57) ABSTRACT

An apparatus includes a body. The apparatus includes a test slot assembly configured to receive and to support a storage device for testing; at least one first vibration management element, disposed between the body and the test slot assembly and configured to disperse a first frequency vibrational energy. The apparatus includes at least one second vibration management element, disposed between the body and the test slot assembly and configured to disperse a second frequency vibrational energy, the first frequency vibrational energy having a first frequency that is above a second frequency of the second frequency vibrational energy.

### TECHNICAL FIELD

This disclosure relates to managing energy transmission and related devices, systems, and methods.

### BACKGROUND

Storage device manufacturers typically test manufactured storage devices for compliance with a collection of requirements. Test equipment and techniques exist for testing large numbers of storage devices serially or in parallel. Manufacturers tend to test large numbers of storage devices simultaneously or in batches. Storage device testing systems typically include one or more tester racks having multiple test slots that receive storage devices for testing. In some cases, the storage devices are placed in carriers which are used for loading and unloading the storage devices to and from the test racks.

The testing environment immediately around the storage device may be regulated. The latest generations of disk drives, which have higher capacities, faster rotational speeds and smaller head clearance, are more sensitive to vibration. Excess vibration can affect the reliability of test results and the integrity of electrical connections. Under test conditions, the drives themselves can propagate vibrations through supporting structures or fixtures to adjacent units. This vibration “cross-talking,” together with external sources of vibration, contributes to bump errors, head slap and non-repetitive run-out (NRRO), which may result in lower yields and increased manufacturing costs. Current disk drive testing systems employ automation and structural support systems that contribute to excess vibrations in the system and/or require large footprints.

### DESCRIPTION OF DRAWINGS

FIG. 1 is a perspective view of a storage device testing system.

FIG. 2A is perspective view of a test rack.

FIG. 2B is a detailed perspective view of a carrier receptacle from the test rack of FIG. 2A.

FIGS. 3A and 3B are perspective views of a test slot carrier.

FIG. 4 is a perspective view of a test slot assembly.

FIG. 5 is a top view of a storage device testing system.

FIG. 6 is a perspective view of a storage device testing system.

FIGS. 7A and 7B are perspective views of a storage device transporter.

FIG. 8A is a perspective view of a storage device transporter supporting a storage device.

FIG. 8B is a perspective view of a storage device transporter receiving a storage device.

FIG. 8C is a perspective view of a storage device transporter carrying a storage device aligned for insertion into a test slot.

FIG. 9 is a schematic view of test circuitry.

FIG. 10 is a perspective view of a body of a test slot carrier.

FIGS. 11A and 11B are perspective views of a main body member from the body of FIG. 10.

FIGS. 12A and 12B are perspective views of a first side support member from the body of FIG. 10.

FIGS. 13A and 13B are perspective views of a second side support member from the body of FIG. 10.

FIGS. 14A and 14B are perspective views of a third side support members from the body of FIG. 10.

FIGS. 15A and 15B are perspective views of a test slot housing.

FIGS. 16A and 16B are perspective views of a test slot carrier.

FIG. 17 is a perspective view of an vibration management element.

FIG. 18 is a perspective view of a test slot.

FIG. 19 is a perspective view of a connection interface board.

FIGS. 20A and 20B are perspective views of an air mover assembly.

Like reference symbols in the various drawings indicate like elements.

### DETAILED DESCRIPTION

The present disclosure provides techniques for managing the transmission of vibrational or impact energy between elements of a storage device testing system. For example, one or more vibration management elements can be provided between a test slot assembly and a structure that supports one or more test slot assemblies (e.g., a test slot carrier). In some examples, the vibration management elements can include a first vibration management element for managing low-frequency vibration, and a second vibration management element for managing high-frequency vibration (where “high” and “low” refer to relative frequency values in which the high frequency is above the low frequency). While we refer to an “isolator” in some of the examples herein, we use the term isolator broadly to include elements that provide mechanical isolation, dampening, or both. In some examples, the vibration management element for managing low-frequency vibration can be formed from a soft, e.g. gel material, while the vibration management element for managing high-frequency vibration can be formed from a more rigid material.

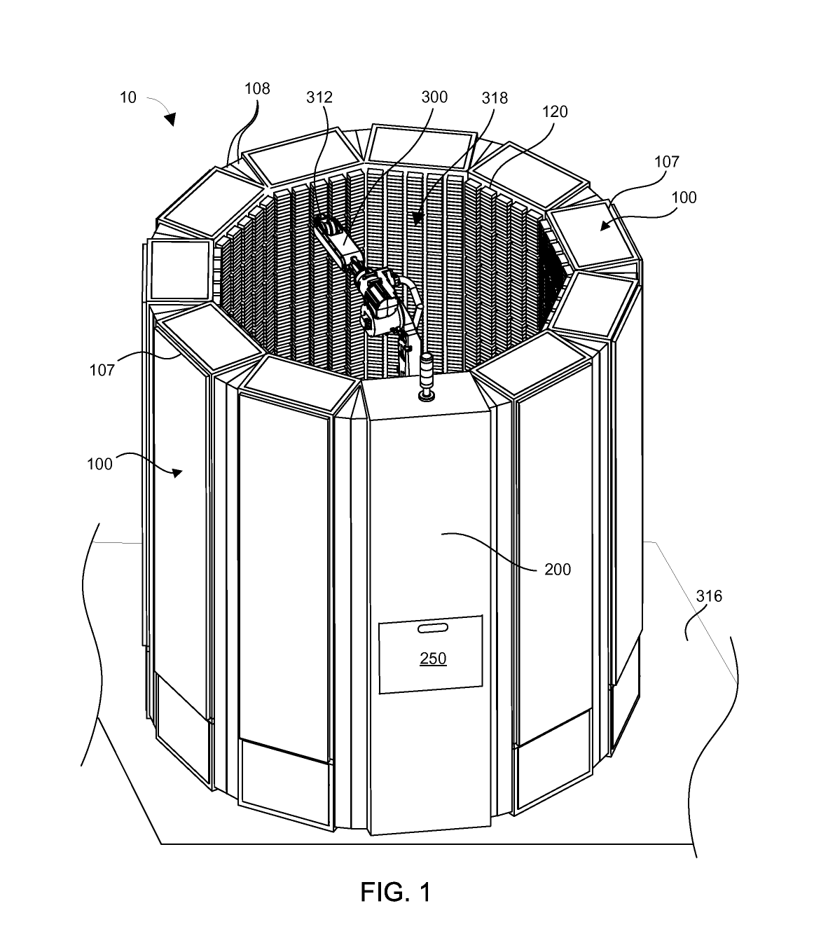

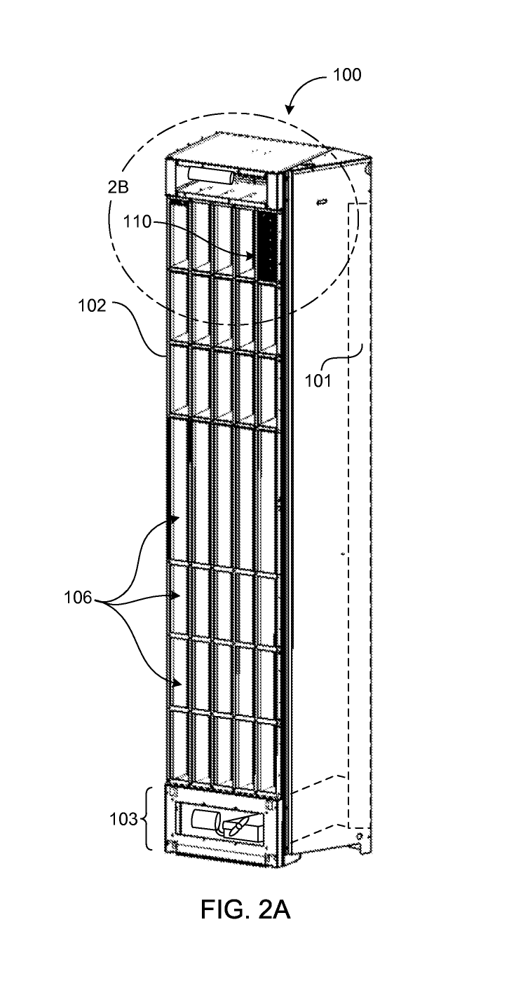

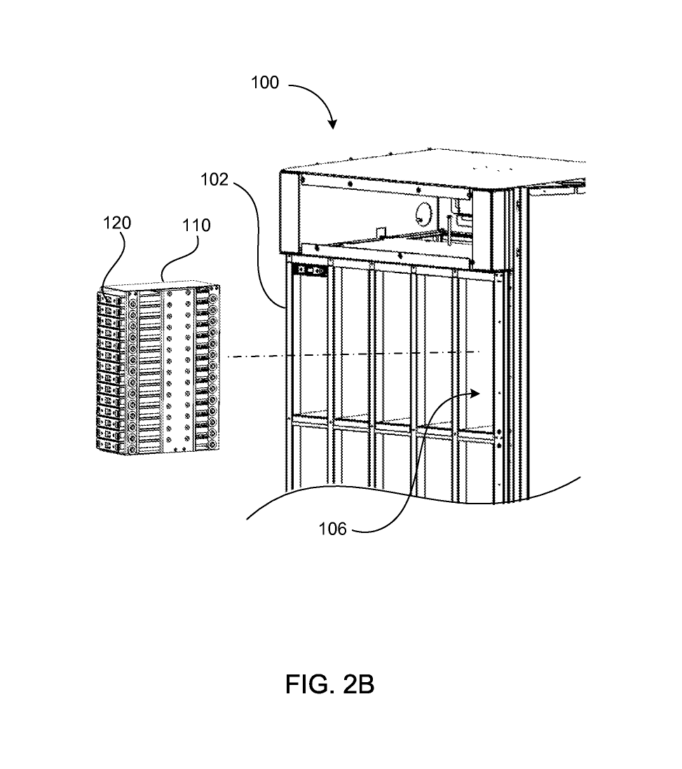

As shown in FIG. 1, a storage device testing system 10 includes a plurality of test racks 100 (e.g., 10 test racks shown), a transfer station 200, and a robot 300. As shown in FIGS. 2A and 2B, each test rack 100 generally includes a chassis 102. The chassis 102 can be constructed from a plurality of structural members 104 (e.g., formed sheet metal, extruded aluminum, steel tubing, and/or composite members) which are fastened together and together define a plurality of carrier receptacles 106.

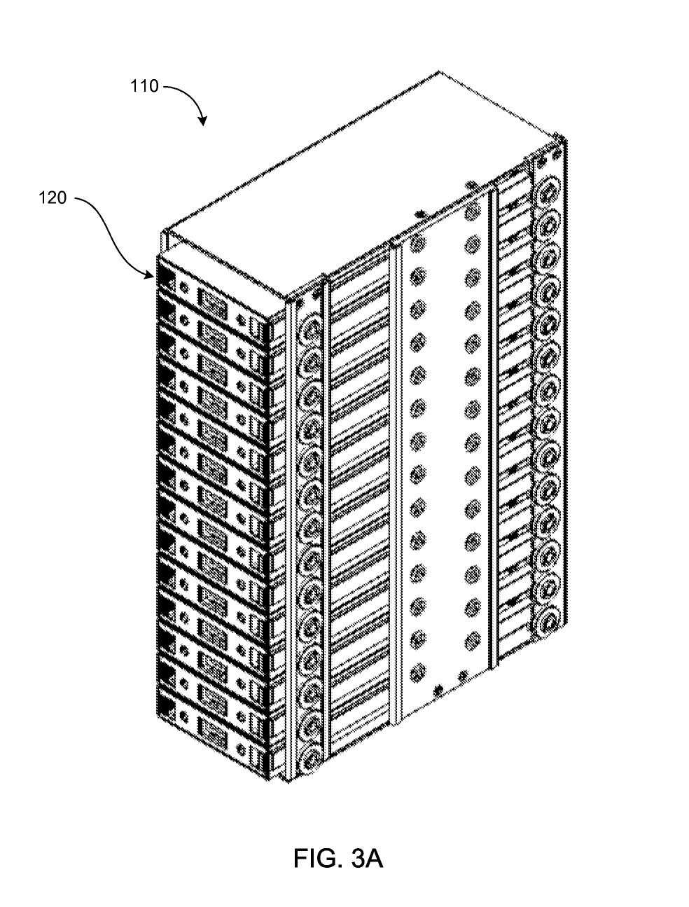

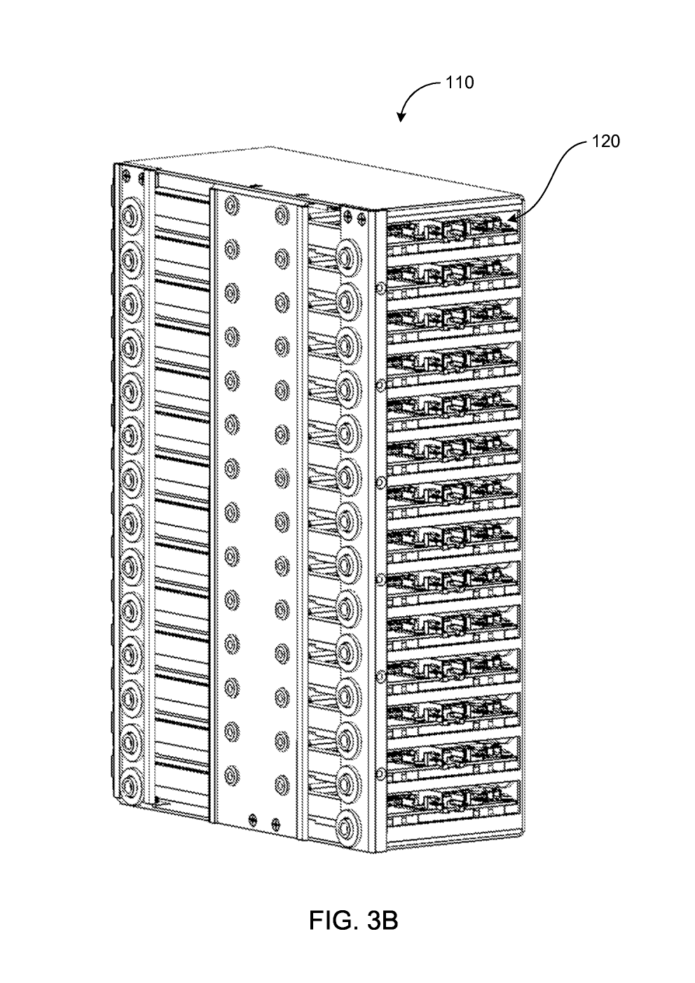

Each carrier receptacle 106 can support a test slot carrier 110. As shown in FIGS. 3A and 3B, each test slot carrier 110 supports a plurality of test slot assemblies 120. Different ones of the test slot carriers 110 can be configured for performing different types of tests and/or for testing different types of storage devices. The test slot carriers 110 are also interchangeable with each other within among the many carrier receptacles 106 within the testing system 10 allowing for adaptation and/or customization of the testing system 10, e.g., based on testing needs. In the example shown in FIGS. 2A and 2B, an air conduit 101 provides pneumatic communication between each test slot assembly 120 of the respective test rack 100 and an air heat exchanger 103. The air heat exchanger 103 is disposed below the carrier receptacles 106 remote to received test slot carriers 110.

A storage device, as used herein, includes disk drives, solid state drives, memory devices, and any device that benefits from asynchronous testing. An example of a disk drive is generally a non-volatile storage device which stores digitally encoded data on rapidly rotating platters with magnetic surfaces. An example of a solid-state drive (SSD) is a data storage device that uses solid-state memory to store persistent data. An SSD using SRAM or DRAM (instead of flash memory) is often called a RAM-drive. The term solid-state generally distinguishes solid-state electronics from electromechanical devices.

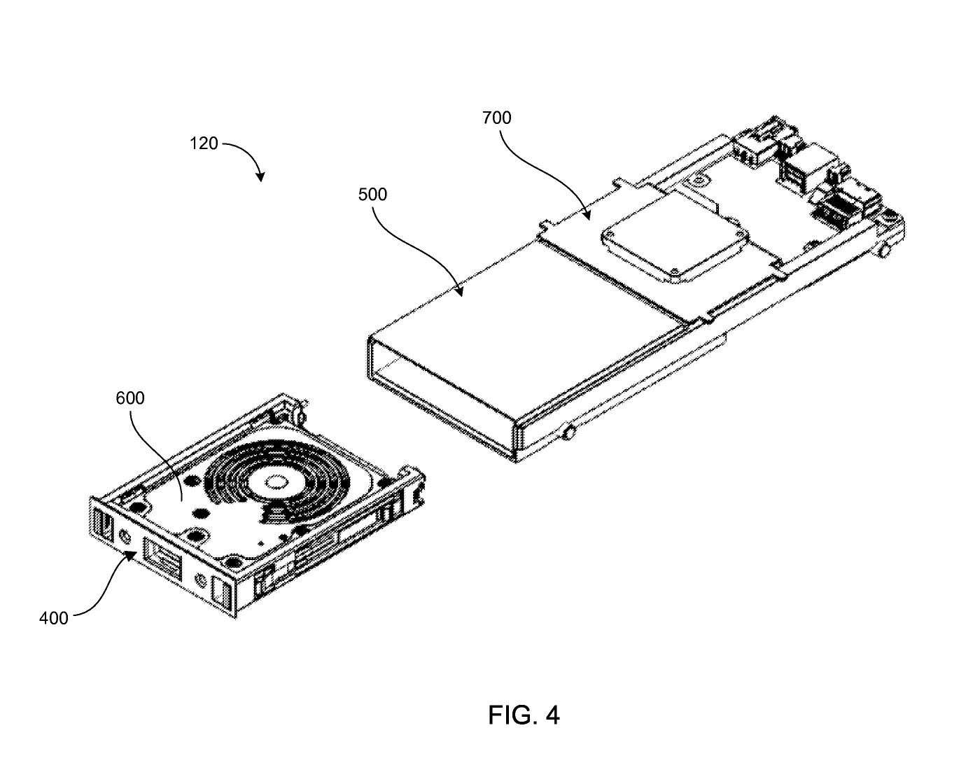

As shown in FIG. 4, each test slot assembly 120 includes a storage device transporter 400, a test slot 500, and an associated air mover assembly 700. The storage device transporter 400 may be used for capturing storage devices 600 (e.g., from the transfer station 200) and for transporting the storage device 600 to one of the test slots 500 for testing.

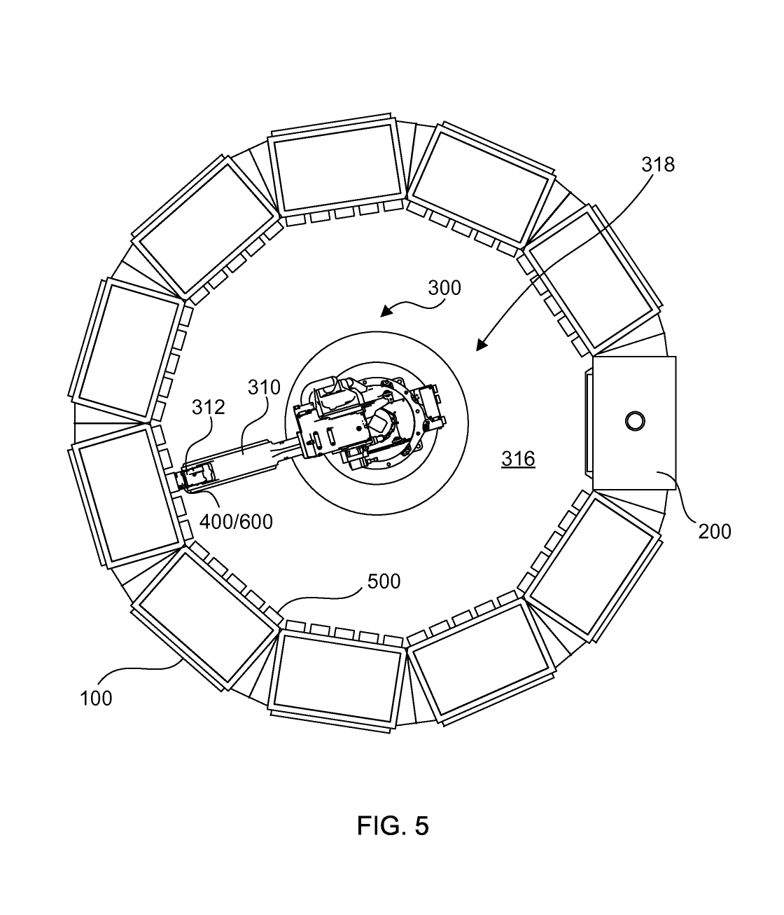

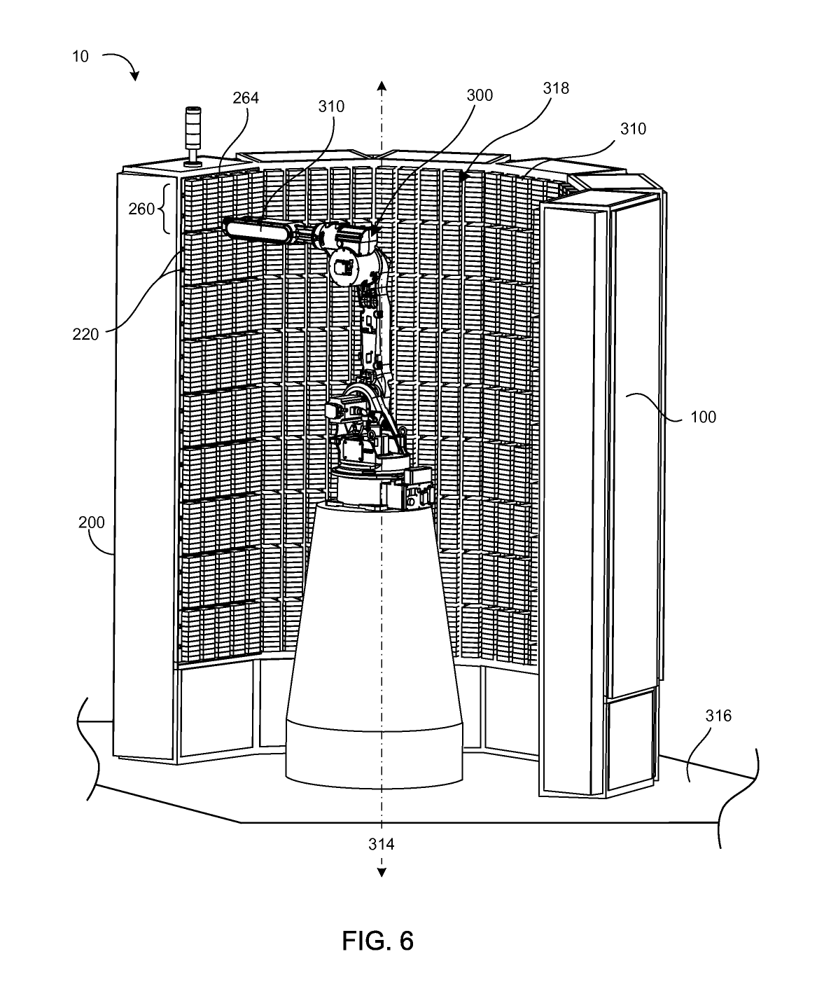

Referring to FIGS. 5 and 6, the robot 300 includes a robotic arm 310 and a manipulator 312 (FIG. 5) disposed at a distal end of the robotic arm 310. The robotic arm 310 defines a first axis 314 (FIG. 6) normal to a floor surface 316 and is operable to rotate through a predetermined arc about and extends radially from the first axis 314 within a robot operating area 318. The robotic arm 310 is configured to independently service each test slot 500 by transferring storage devices 600 between the transfer station 200 and the test racks 100. In some embodiments, the robotic arm 310 is configured to remove a storage device transporter 400 from one of the test slots 500 with the manipulator 312, then pick up a storage device 600 from the transfer station 200 with the storage device transporter 400, and then return the storage device transporter 400, with a storage device 600 therein, to the test slot 500 for testing of the storage device 600. After testing, the robotic arm 310 retrieves the storage device transporter 400, along with the supported storage device 600, from one of the test slots 500 and returns it to the transfer station 200 (or moves it to another one of the test slots 500) by manipulation of the storage device transporter 400 (i.e., with the manipulator 312). In some embodiments, the robotic arm 310 is configured to pick up a storage device 600 from the transfer station 200 with the manipulator 312, then move the storage device 600 to a test slot 500, and deposit the storage device 600 in the test slot 500 by depositing the storage device 600 in the storage device transporter 400 and then inserting the storage device transporter in the test slot 500. After testing, the robotic arm 310 uses the manipulator 312 to remove the storage device 600 from the storage device transporter 400 and return it to the transfer station 200.

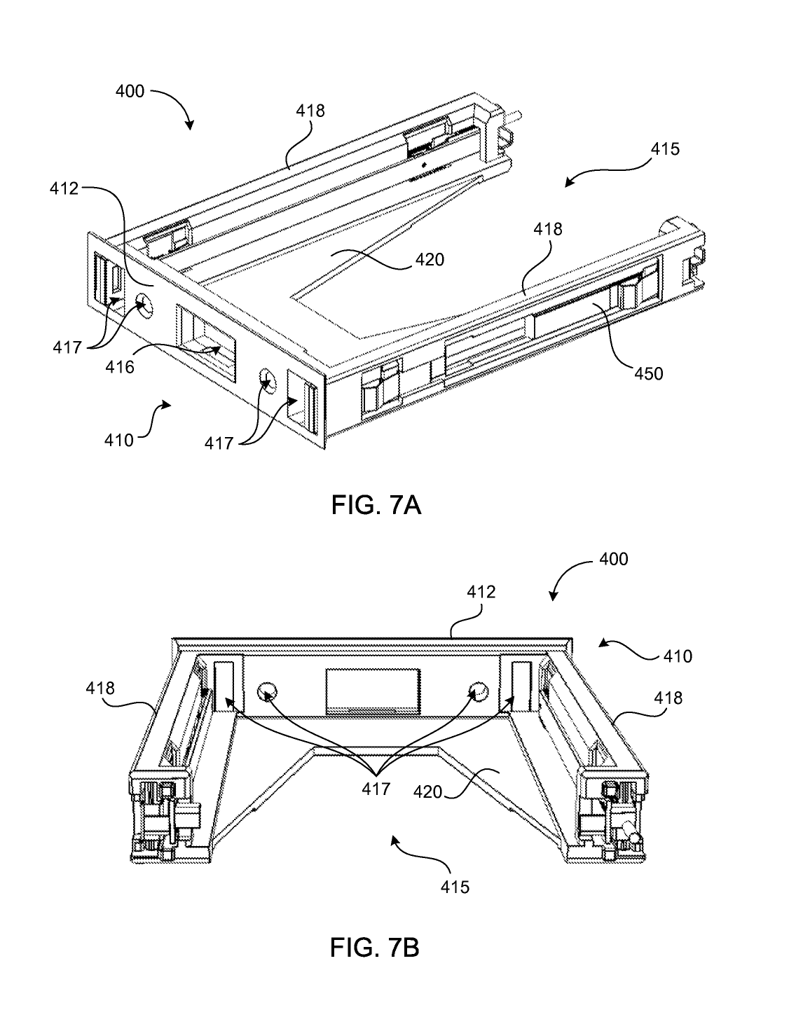

Referring to FIGS. 7A and 7B, the storage device transporter 400 includes a frame 410 and a clamping mechanism 450. The frame 410 includes a face plate 412. As shown in FIG. 7A, face plate 412 defines an indentation 416. The indentation 416 can be releaseably engaged by the manipulator 312 (FIG. 5) of the robotic arm 310, which allows the robotic arm 310 to grab and move the transporter 400. In use, one of the storage device transporters 400 is removed from one of the test slots 500 with the robot 300 (e.g., by grabbing, or otherwise engaging, the indentation 416 of the transporter 400 with the manipulator 312 of the robot 300). The frame 410 defines a substantially U-shaped opening 415 formed by sidewalls 418 and a base plate 420.

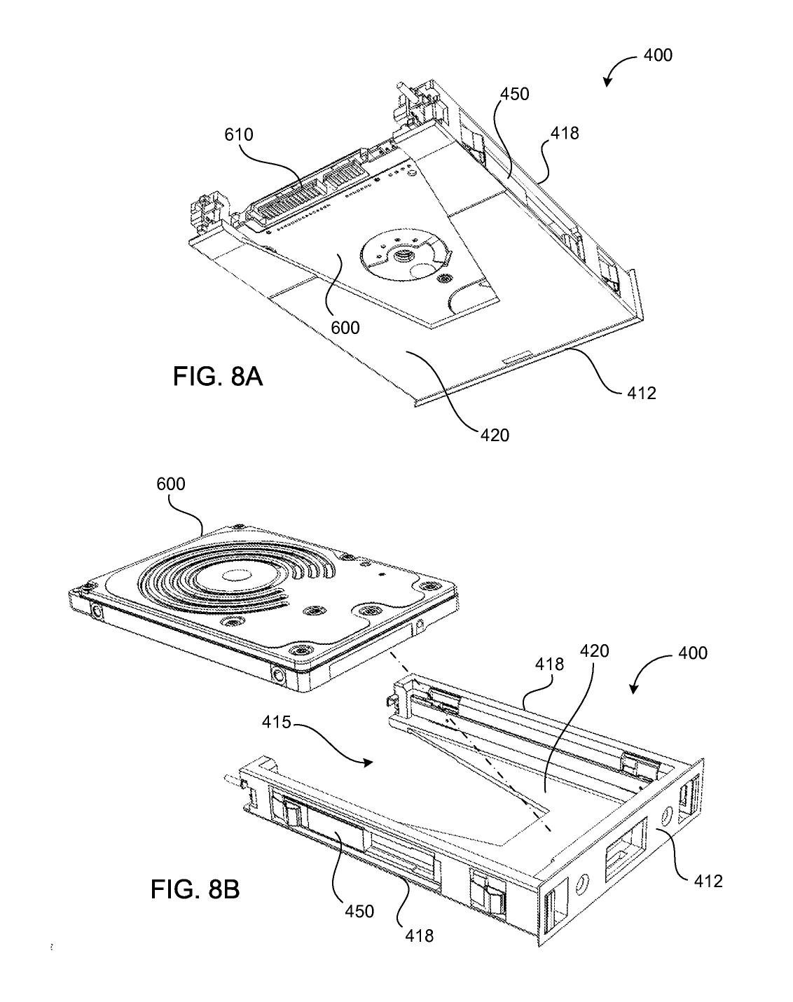

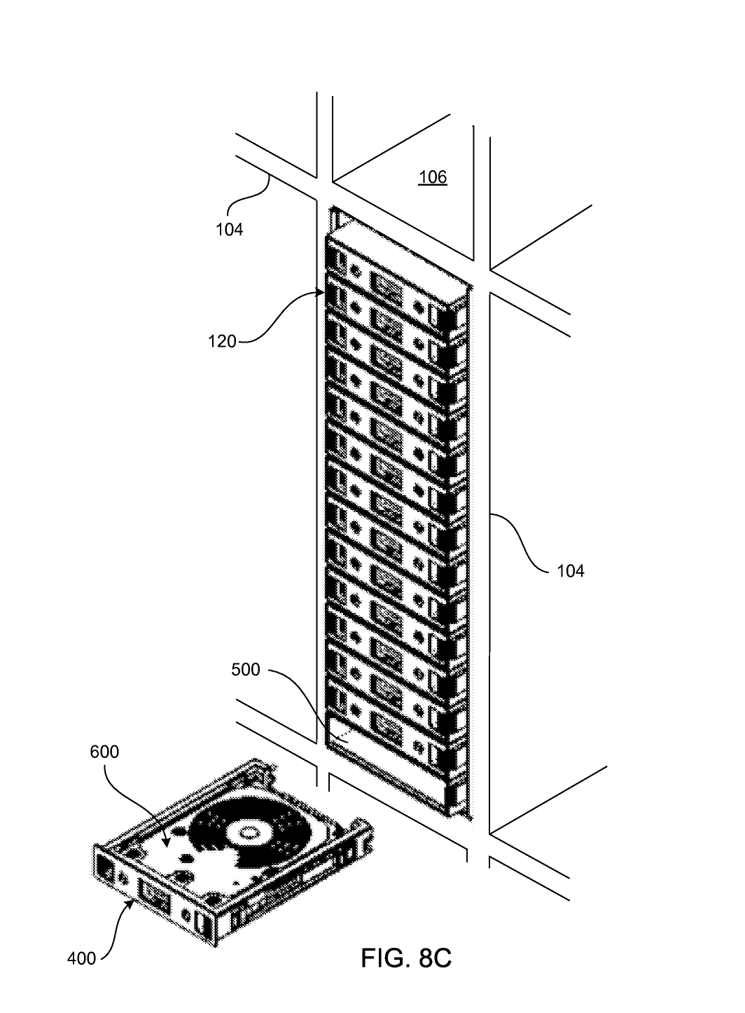

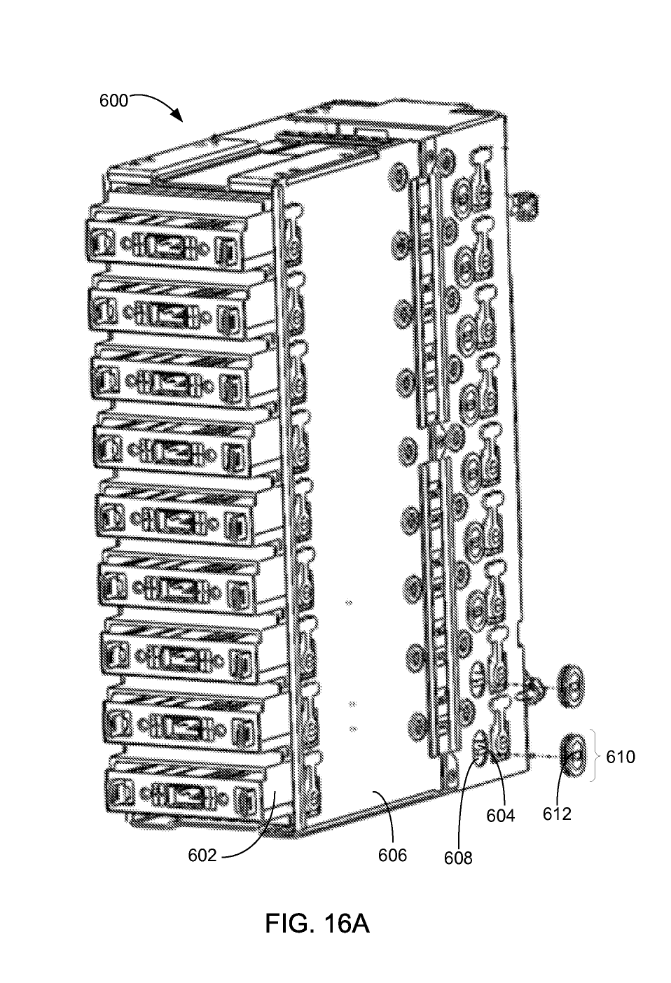

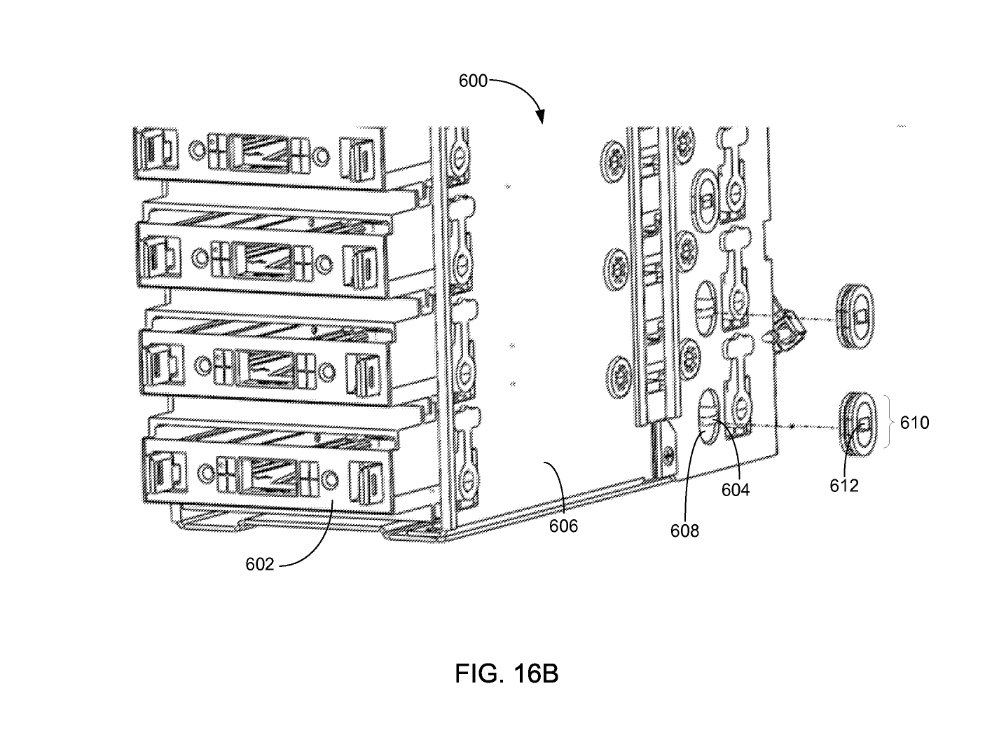

Referring to FIGS. 8A, 8B, and 8C, with the storage device 600 in place within the frame 410 of the storage device transporter 400, the storage device transporter 400 and the storage device 600 together can be moved by the robotic arm 310 (FIG. 5) for placement within one of the test slots 500. The manipulator 312 (FIG. 5) is also configured to initiate actuation of a clamping mechanism 450 disposed in the storage device transporter 400. Actuating the clamping mechanism 450 inhibits movement of the storage device 600 relative to the storage device transporter 400. Releasing the clamping mechanism 450 allows for insertion of the storage device transporter 400 into one of the test slots 500, until the storage device 600 is in a test position with a storage device connector 610 engaged with a test slot connector 574 (FIG. 16). The clamping mechanism 450 may also be configured to engage the test slot 500, once received therein, to inhibit movement of the storage device transporter 400 relative to the test slot 500. In such implementations, once the storage device 600 is in the test position, the clamping mechanism 450 is engaged again (e.g., by the manipulator 312) to inhibit movement of the storage device transporter 400 relative to the test slot 500. The clamping of the transporter 400 in this manner can help to reduce vibrations during testing.

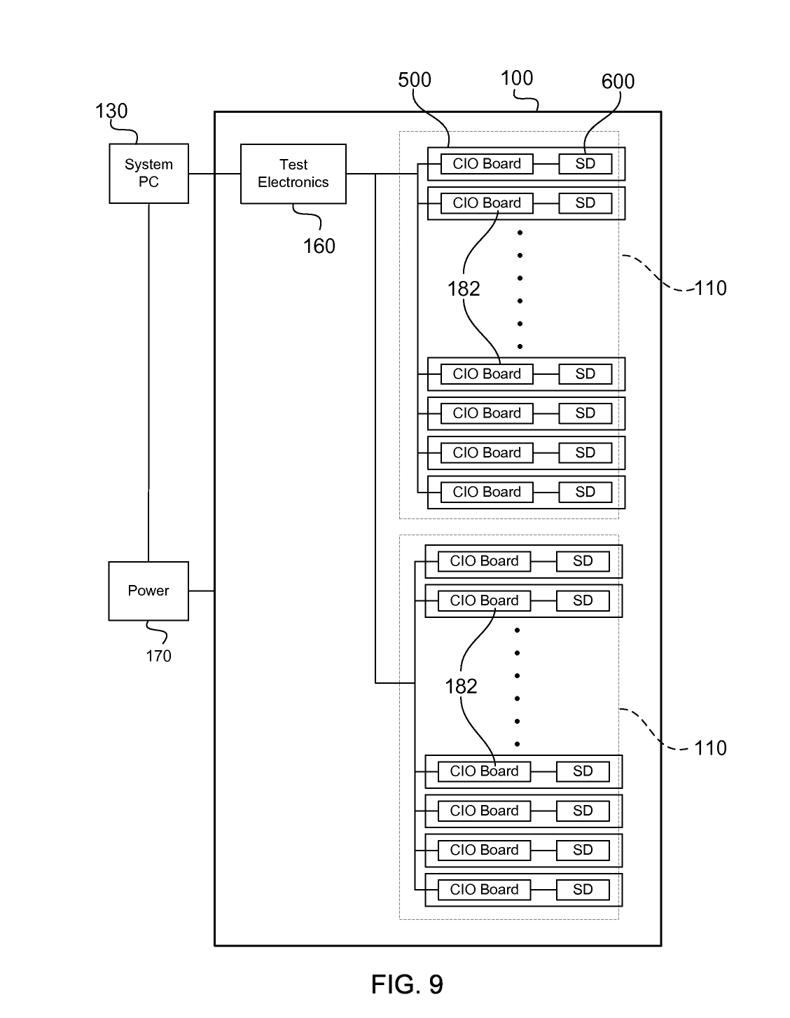

Referring to FIG. 9, in some implementations, the storage device testing system 10 can also include at least one computer (system PC) 130 in communication with the test slots 500. The computer 130 may be configured to provide inventory control of the storage devices 600 and/or an automation interface to control the storage device testing system 10. Test electronics 160 are in communication with each test slot 500. The test electronics 160 are in electrical communication with connection interface circuits 182 that are disposed within each the test slots 500. These connection interface circuits 182 are arranged for electrical communication with a storage device 600 received within the associated test slot 500, and thereby provide for communication between the test electronics 160 and storage devices 600 within the test slots 500, e.g., for executing test routines. The test routines may include a functionality test, which can include testing the amount of power received by the storage device 600, the operating temperature, the ability to read and write data, and the ability to read and write data at different temperatures (e.g. read while hot and write while cold, or vice versa). The functionality test may test every memory sector of the storage device 600 or only random samplings. The functionality test may test an operating temperature of the storage device 600 and also the data integrity of communications with the storage device 600.

As shown in FIG. 9, a power system 170 supplies power to the storage device testing system 10. The power system 170 may monitor and/or regulate power to the received storage device 600 in the test slot 500.

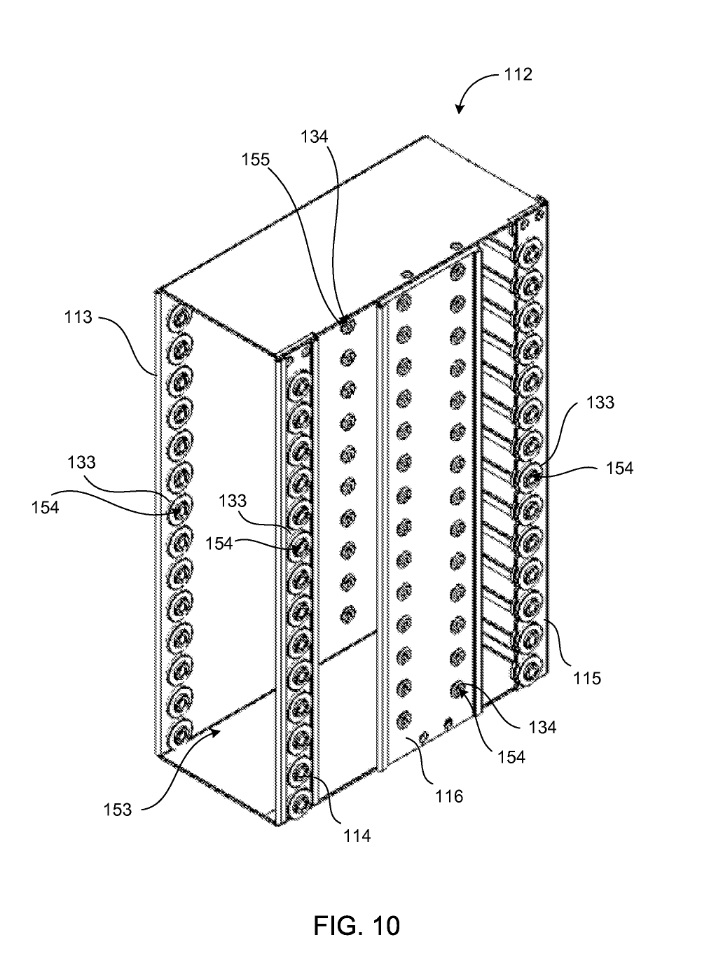

All of the test slot carriers 110 can have the same general construction. The test slot carriers 110 (FIG. 3) generally include a body 112 which supports one or more of the test slot assemblies 120 (FIG. 4). Referring to FIG. 10, the body 112 includes a main body member 113, and side support members (i.e., first, second, and third side support members 114, 115,116). The main body member 113 and side support members 114, 115, 116 can each be formed of one or more sheet metal and/or molded plastic parts.

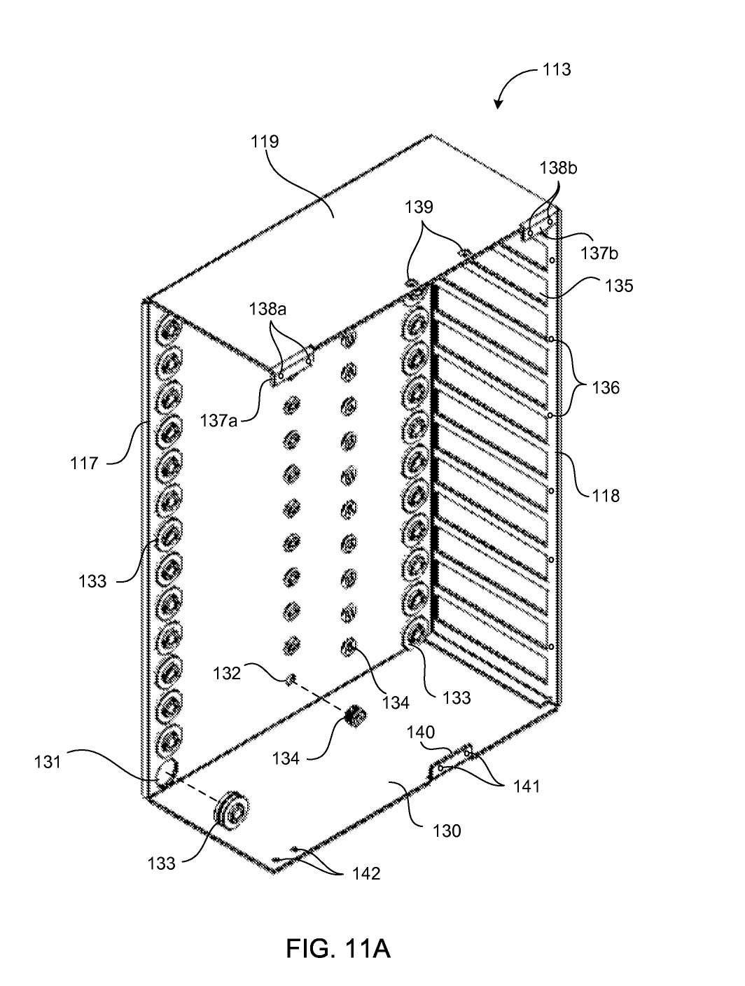

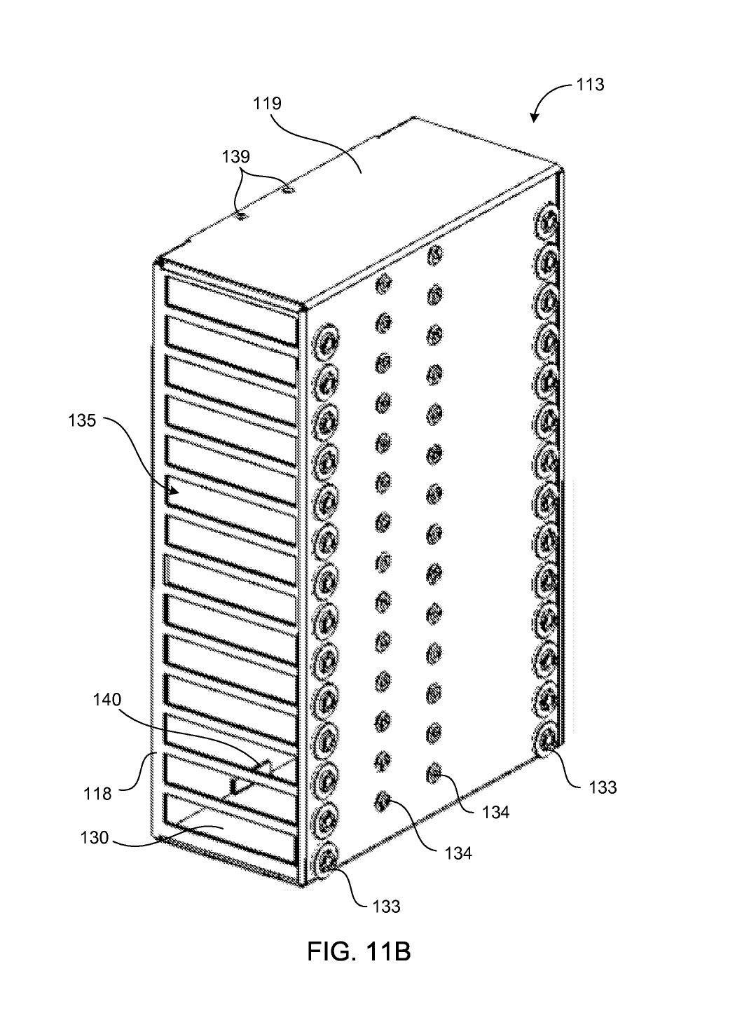

Referring to FIGS. 11A and 11B, the main body member 113 includes a side wall portion 117, a back wall portion 118, a top wall portion 119, and a bottom wall portion 130. The side wall portion 117 includes a plurality of first apertures 131 (FIG. 11A) and a plurality of second apertures 132 (FIG. 11A). The side wall portion 117 also includes a plurality of first isolators (e.g., first grommets 133), each disposed within one of the first apertures 131, and a plurality of second isolators (e.g., second grommets 134), each disposed within one of the second apertures 132. The first and second grommets 133, 134 serve as interfaces between the body 112 and the test slot assemblies 120. The first grommets 133 may be formed from a mechanical vibration dispersing material, such as thermoplastic vinyl, e.g., having a durometer of between about 35 shore A and about 60 shore A. The second grommets 134 may be formed from a mechanical vibration dispersing material, such as thermoplastic vinyl, e.g., having a durometer of between about 35 shore A and about 60 shore A.

The back wall portion 118 includes a plurality of rectangular openings 135 and a plurality of threaded holes 136, which receive mounting hardware (e.g., screws) for securing the second side support member 115 to the back wall portion 118.

The top wall portion 119 includes a pair of mounting tabs 137a, 137b with threaded holes 138a, 138b, which receive mounting hardware (e.g., screws) for connection with the first and second side support members 114, 115. The top wall portion 119 also includes through-holes 139, which receive mounting hardware (e.g., screws) for connecting the third side support member 116 to the top wall portion 119.

The bottom wall portion 130 includes a mounting tab 140 with threaded holes 141, which receive mounting hardware (e.g., screws) for connecting the third side support member 116 to the bottom wall portion 130. The bottom wall portion 130 also includes through-holes 142, which receive mounting hardware (e.g., screws) for connecting the first side support member 114 to the bottom wall portion 130.

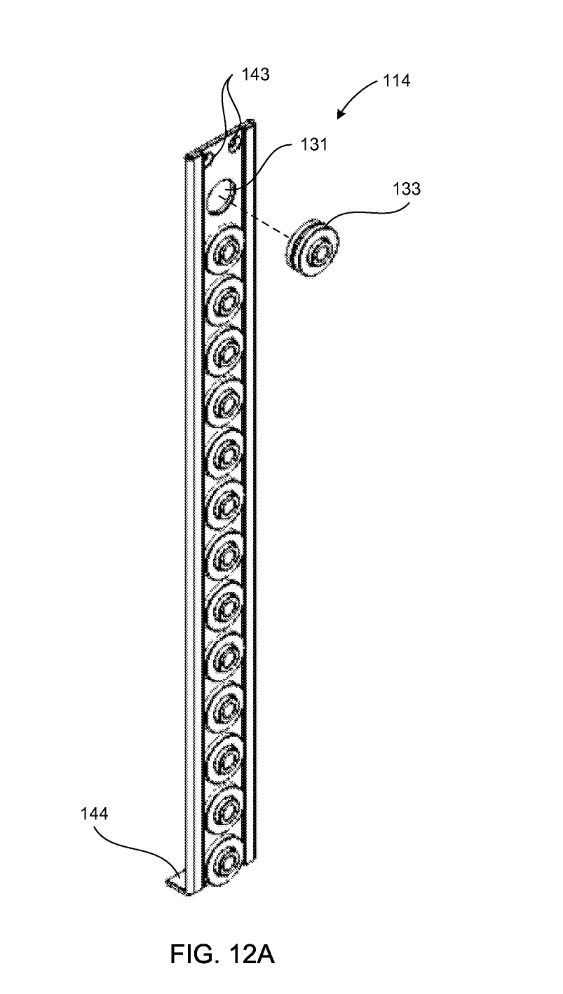

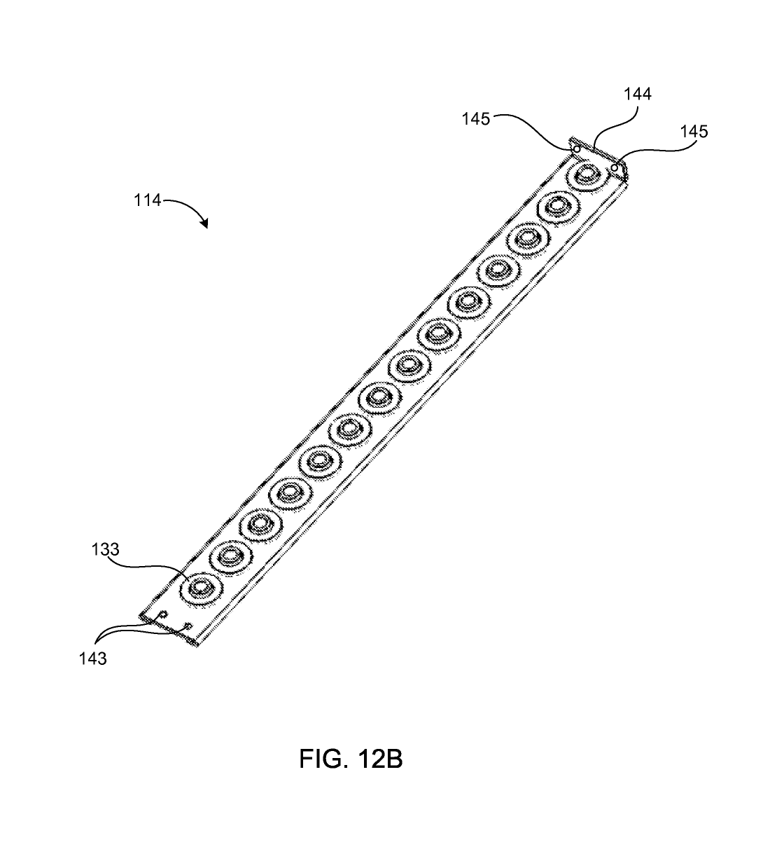

Referring to FIG. 12A, the first side support member 114 includes a plurality of the first apertures 131 and a plurality of the first isolators (e.g., the first grommets 133) each disposed within one of the first apertures 131. The first side support member 114 also includes through-holes 143, which align with the threaded holes 138a of the main body member 113 and allow the first side support member 114 to be mounted to the main body member 113. As shown in FIG. 12B, the first side support member 114 also includes a flange 144 with threaded holes 145. The threaded holes 145 align with the through holes 142 in the bottom wall portion 130 and receive mounting hardware (e.g., screws), for securing the first side support member 114 to the bottom wall portion 130.

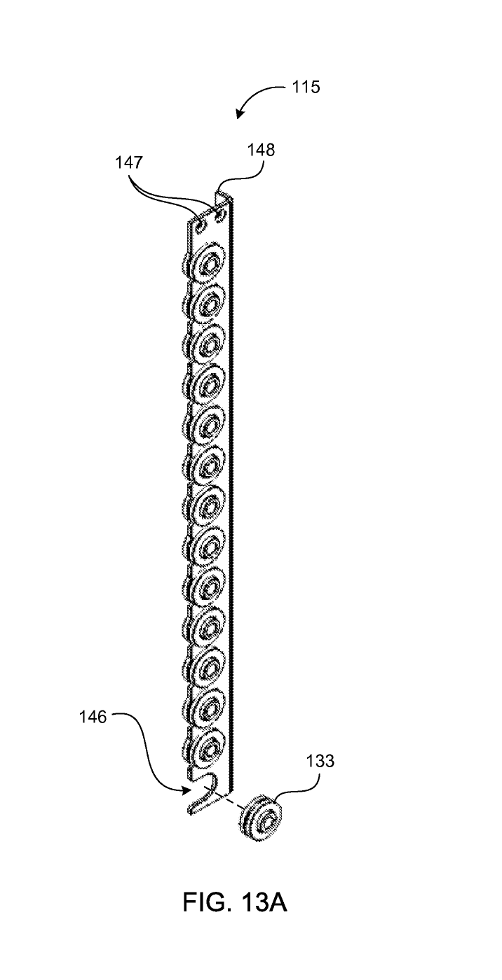

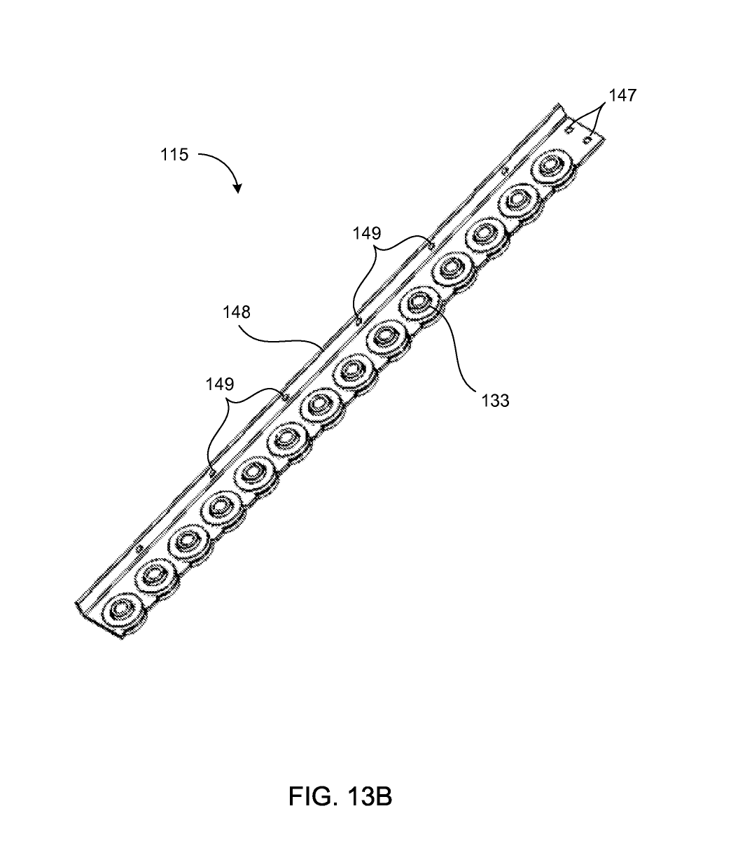

Referring to FIG. 13A, the second side support member 115 includes a plurality of recesses 146 and a plurality of the first isolators (e.g., the first grommets 133) each disposed within one of the recesses 146. The second side support member 115 also includes through-holes 147, which align with the threaded holes 138b of the main body member 113 and allow the second side support member 115 to be mounted to the main body member 113. As shown in FIG. 13B, the second side support member 115 also includes a lip 148 with through-holes 149. The through-holes 149 align with the threaded holes 136 in the back wall portion 118 (FIG. 11A) and receive mounting hardware (e.g., screws), for securing the second side support member 115 to the back wall portion 118.

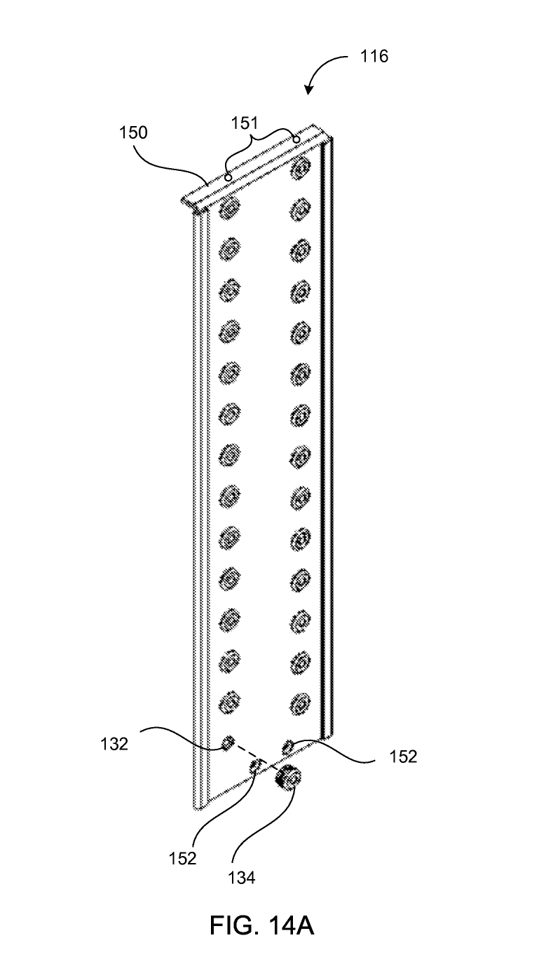

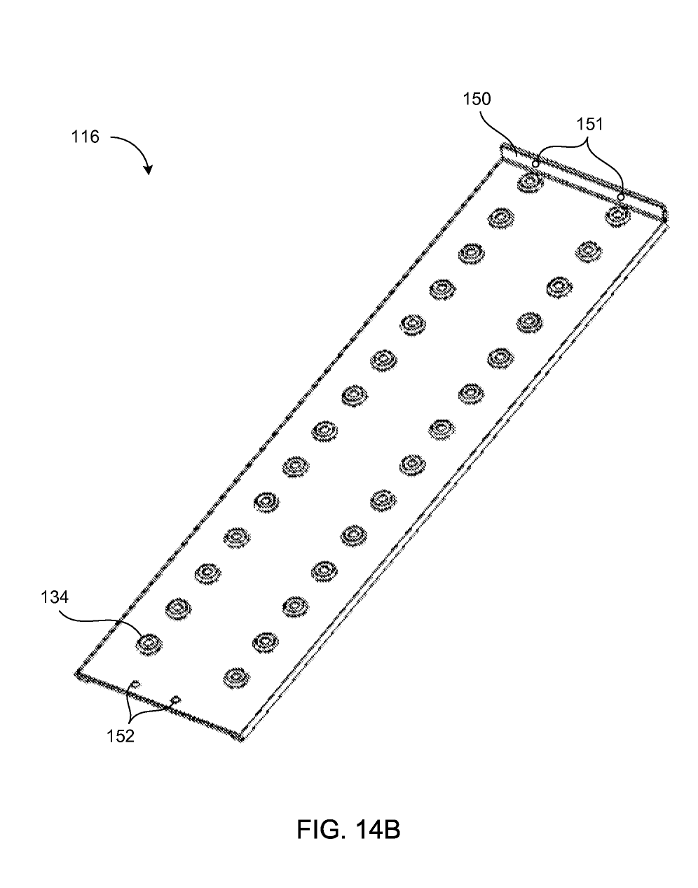

Referring to FIGS. 14A and 14B, the third side support member 116 includes a plurality of the second apertures 132 and a plurality of the second isolators (e.g., the second grommets 134) each disposed within one of the second apertures 132. The third side support member 116 also includes a mounting tab 150 with threaded holes 151. The threaded holes 151 align with the through-holes 139 (FIG. 11A) in the top wall portion 119, which allows the third side support member 116 to be connected to the top wall portion 119 (e.g., with screws). The third side support member 116 also includes through-holes 152. The through-holes 152 align with the threaded holes 141 in the bottom wall portion 130 (FIG. 11A), which allows the third side support member 116 to be connected to the bottom wall portion 130 (e.g., with screws).

The main body member 113 and side support members 114, 115, 116 together define a cavity 153 (FIG. 10) for receiving the test slot assemblies 120. Corresponding features of the test slot assemblies 120 interface with the first and second grommets 133, 134 in the main body member 113 and support members 114, 115, 116, which, in turn, allows the test slot assemblies 120 to be supported within the cavity 153 (as shown, e.g., in FIG. 3).

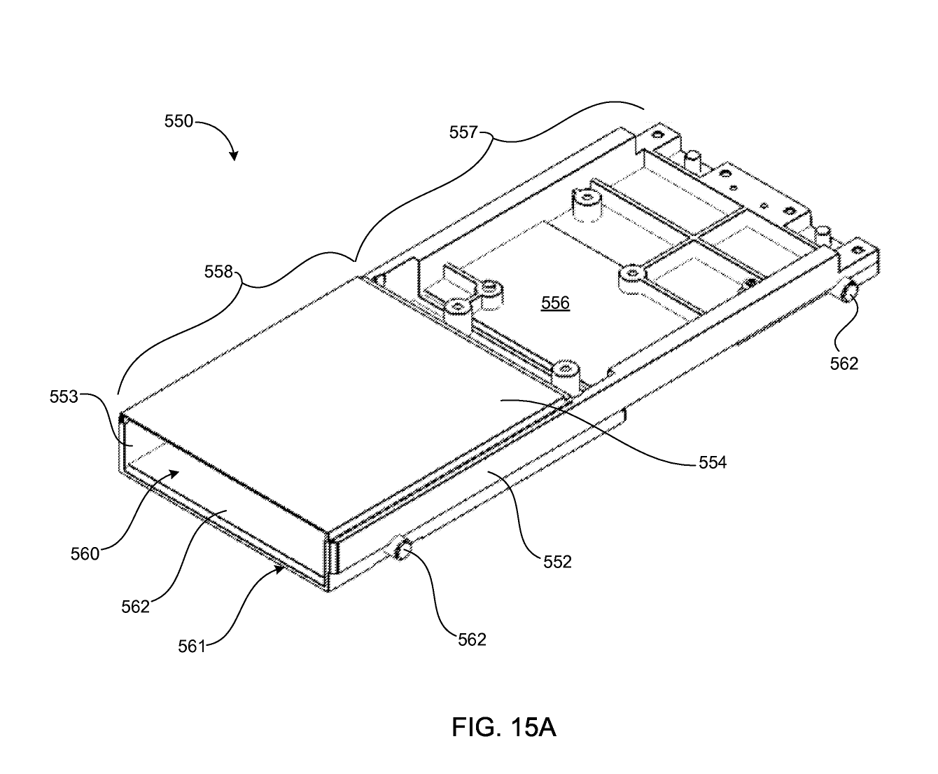

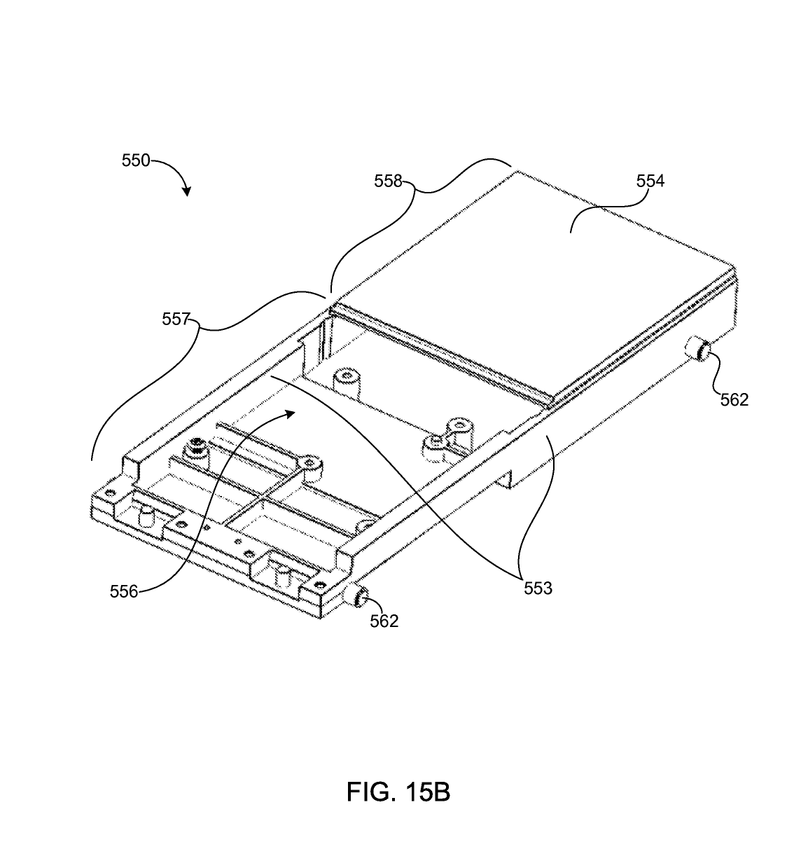

Referring to FIGS. 15A and 15B, each of the test slots 500 includes a housing 550 having a base 552, upstanding walls 553, and a cover 554. In the illustrated embodiment, the cover 554 is integrally molded with the base 552 and the upstanding walls 553. The housing 550 defines an internal cavity 556 which includes a rear portion 557 and a front portion 558. The front portion 558 defines a test compartment 560 for receiving and supporting one of the storage device transporters 400.

The base 552, upstanding walls 553, and the cover 554 together define a first open end 561, which provides access to the test compartment 560 (e.g., for inserting and removing the storage device transporter 400).

The upstanding walls 533 include outwardly extending protrusions 562. In some examples, the protrusions 562 can interface with apertures in a test slot carrier (e.g., the first apertures 131 in the body 112 shown in FIG. 11A), and may also interface with grommets positioned within apertures (e.g., the first grommets 133). Arranging the protrusions 562 within apertures in the body of a test slot carrier can help to support the test slots within the test slot carrier. By way of example, when assembled with the body 112, the protrusions 562 each sit within a hole 154 (FIG. 10) in a corresponding one of the first grommets 133. The first grommets 133, being formed of a mechanical vibration dispersing material, inhibit the transmission of vibrations between the test slots 500 and the body 112, and also absorb vibrational energy by transforming it in to heat. The grommets 133 may be formed of a material such as a thermoplastic material or a thermoset material. In some examples, the grommets have a durometer of more than about 40 Shore A (e.g., about 50 Shore A). In some examples, the grommets 133 can be configured to disperse vibrational energy that is transmitted at a frequency between about 50 Hz to about 4000 Hz.

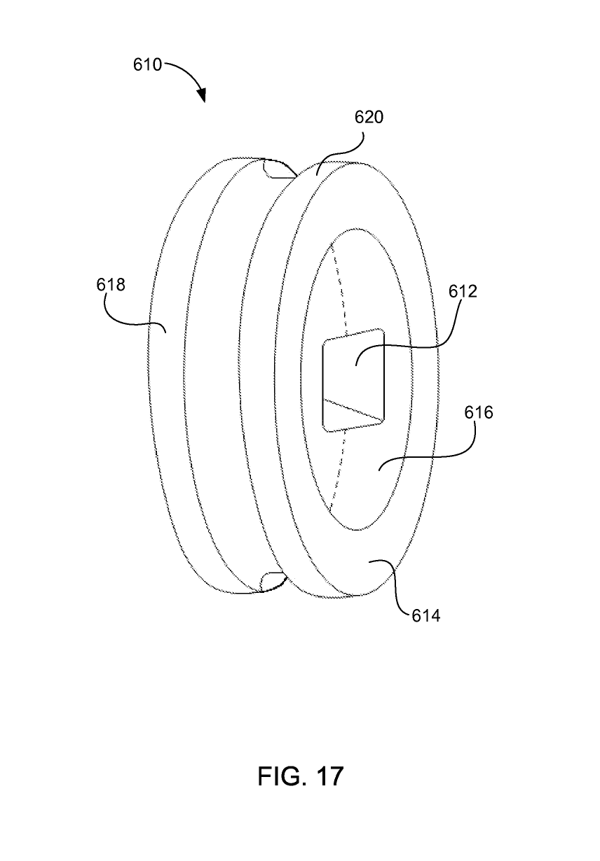

FIGS. 16A and 16B show different views of a test slot carrier 600 that includes a plurality of test slot assemblies, such as the test slot assembly 602. As described above, using the test slot assembly 602 as an example, the test slot assembly 602 includes a protrusion 604 that extends outwardly from a surface of the test slot assembly 602. In some examples, the protrusion 604 can be similar to the protrusion 562 described above. For example, when the test slot assembly 602 is positioned within the test slot carrier 600, the protrusion 604 can be positioned to extend at least partially through an aperture 608 formed in the body 606 of the test slot carrier 600. The protrusion 604 can be configured to interface with a corresponding hole 612 in a vibration management element 610 (shown in greater detail in FIG. 17) when the vibration management element 610 is positioned within the aperture 608 such that the hole 612 aligns with the protrusion 604. In some examples, the vibration management element can disperse vibration, and may, in some examples, be deployed as isolators. In some examples, the vibration management element 610 can be shaped to encircle the protrusion 604 about a longitudinal axis of the protrusion 604 and may maintain substantially continuous contact with the protrusion 604.

When the vibration management element 610 is positioned within the aperture 608 and the protrusion 604 has engaged with the hole 612, the vibration management element 610 adds additional vibration dispersion material between the test slot assembly 602 and the body 606 of the test slot carrier 600. As shown in FIG. 17, the vibration management element 610 may be formed of an outer ring 614 surrounding a low-frequency vibration management element 616. In some examples, the outer ring 614 can form flanges 618, 620 for accepting the body 606 of the test slot carrier 600 therebetween when the vibration management element 610 is positioned, for example, within the aperture 608. The flanges 618, 620 can be shaped such that the vibration management element 610 forms a grommet. The outer ring 614 is configured to hold the low-frequency vibration management element 616 in position between the hole 612 and the flanges 618 and 620. The low-frequency vibration management element 616 may include a dampening material (e.g., a thermoplastic material or a thermoset material). The low-frequency vibration management element 616 may also include a gel, such as a styrene gel or a urethane gel. In some examples, the gel can be contained in an outer ring with molded flanges in order to support the gel and hold it around a protrusion. In some examples, this outer ring may be constructed of the same material as the high frequency vibration management element. In some examples, the low-frequency vibration management element 616 may have a durometer of less than 40 Shore A (e.g., a durometer between 15 and 20 Shore 00). In some examples, the low-frequency vibration management element can be configured to inhibit vibrational energy that is transmitted at a frequency between about 0.05 Hz to about 50 Hz. When the vibration management element 610 is positioned within the aperture 608 and the protrusion 604 has engaged with the hole 612, the vibration management element 610 can substantially immediately inhibit rotation of the test slot assembly 602 within the body 604 of the test slot carrier 600. For example, the low-frequency vibration management element 614 can be rigid io enough to provide nearly constant resistance to movement of the test slot assembly 602 relative to the test slot carrier 600. Similarly, the low-frequency vibration management element 614 can continuously inhibit the transmission of low frequency vibrational energy between the test slot assembly 602 and the test slot carrier 600.

In some of the examples above (e.g., the examples shown in FIGS. 16A and 16B) the test slot assembly includes one or more protrusions that are configured to engage corresponding apertures associated with a body of the test slot carrier. However, it is also possible for the test slot carrier to include one or more protrusions that engage corresponding apertures associated with a body of a test slot assembly. In such a case, vibration management element similar to those described above (e.g., the vibration management element 610) can be provided in apertures of the test slot assembly that engage protrusions associated with the test slot carrier.

While we refer to an “isolator” in some of the examples above, we use the term isolator broadly to include elements that provide mechanical isolation, dampening, or both. Furthermore, while the examples above illustrate the use of the isolator 610 with a combination of a plurality of test slot assemblies within a test slot carrier (e.g., as shown in FIG. 16A, 16B), similar isolators can also be used to inhibit and/or dampen vibration, impact, rotation, or other energies between a single test slot assembly and some other supporting structure (e.g., a bracket that accepts a single, mounted test slot assembly). In some examples, vibration management elements can resemble the isolators shown in FIGS. 11A-14B, and may also resemble or act as grommets.

While the examples above show the placement of vibration management elements at certain locations on the test slot carrier and/or test slot assembly, the placement of these isolators are only example locations, and additional and/or alternative placements are possible. Using FIG. 16A as example, the body 606 of the test slot carrier 600 could include one or more additional apertures (e.g., apertures similar to the aperture 608) configured to engage corresponding additional protrusions of the test slot assembly (e.g., protrusions similar to the protrusion 604).

While the vibration management element 610 has been shown to include both a high frequency vibration management element and a low frequency vibration management element, one or more high frequency vibration management elements and one or more low frequency vibration management elements may also be individually provided on the test slot carrier and/or the test slot assembly. For example, high frequency vibration management elements may be provided in apertures and/or to protrusions separately from low frequency vibration management elements, which may be provided in separate apertures and/or to separate protrusions. For example, a high frequency vibration management element can mate with the protrusion 604 and the aperture 608, and a low frequency vibration management element could separately interface with one or more of the body of the test slot carrier 600 and the test slot assembly 602. In some examples, high and low frequency vibration managements elements can be separately applied to surfaces of the test slot io carrier 600 and/or the test slot assembly 602 (e.g., on the inside of the body 606 of the test slot carrier 600).

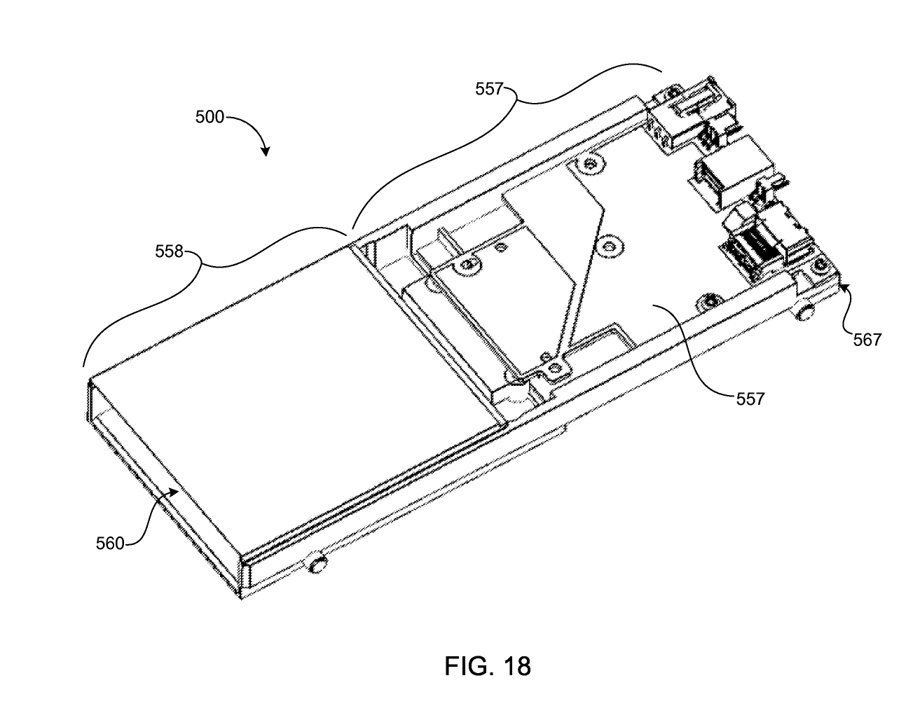

As shown in FIG. 18, the rear portion 557 of the internal cavity 556 houses a connection interface board 570, which carries the associated connection interface circuit 182 (FIG. 9). The connection interface board 570 extends between the test compartment 560 and a second end 567 of the housing 550.

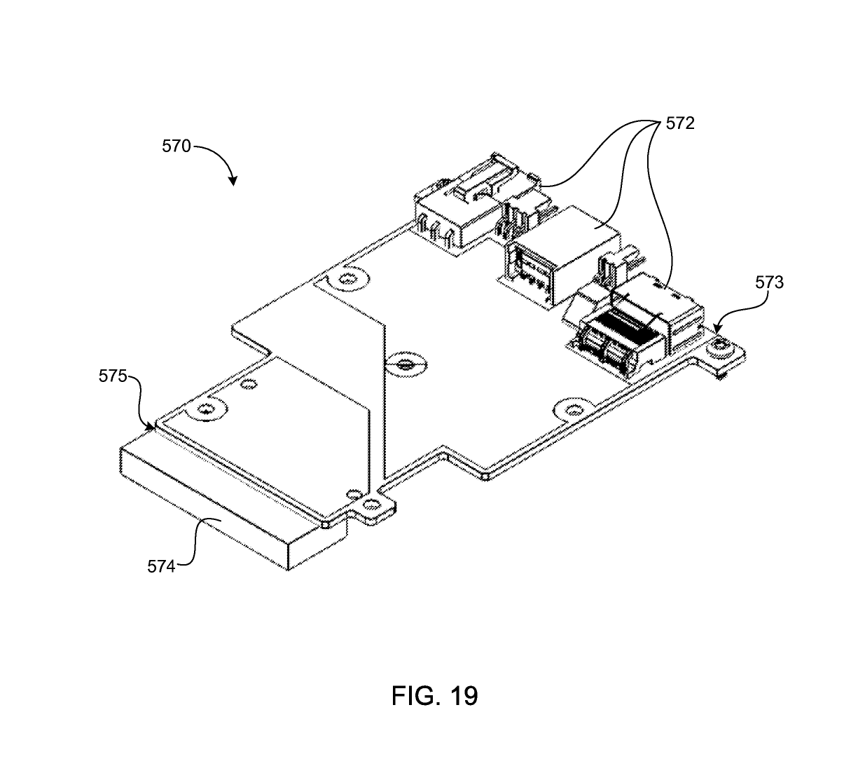

Referring to FIG. 19, a plurality of electrical connectors 572 are disposed along a distal end 573 of the connection interface board 570. The electrical connectors 572 provide for electrical communication between the connection interface circuit 182 and the test electronics 160 (FIG. 9) in the associated test rack 100. When the test slot 500 is mounted within the body 112 (FIG. 10), the electrical connectors 572 are accessible through the rectangular openings 135 in the back wall portion 118 of the main body member 113. The connection interface board 570 also includes a test slot connector 574, arranged at a proximal end 575 of the connection interface board 570, which provides for electrical communication between the connection interface circuit 182 and a storage device 600 in the test slot 500.

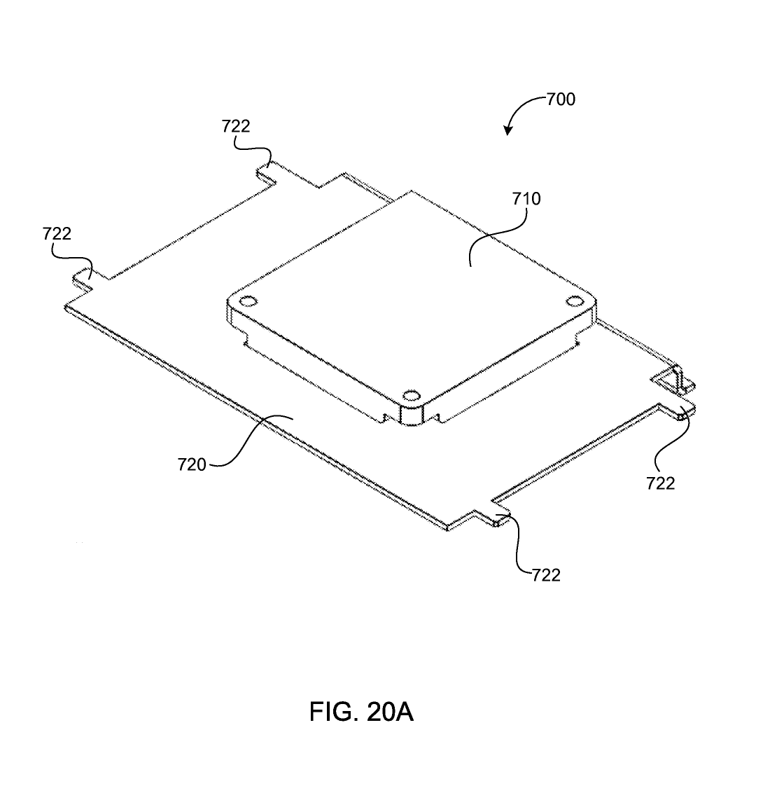

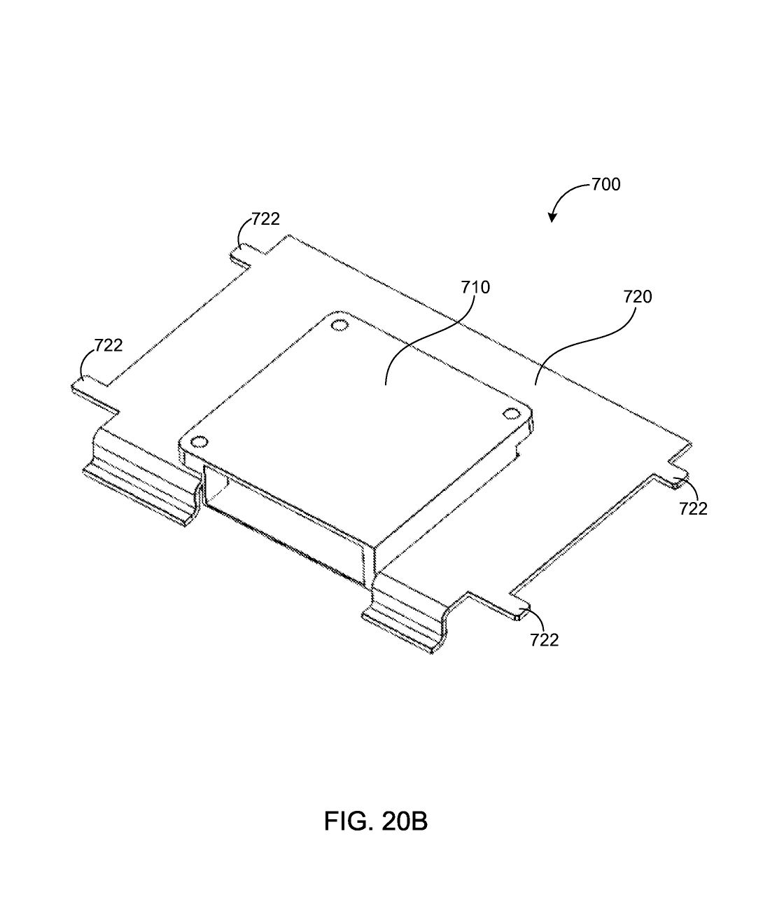

As shown in FIGS. 20A and 20B, each of the air mover assemblies 700 includes an air mover 710 (e.g., a blower) and mounting plate 720 that supports the air mover 710. The air mover assemblies 700 are arranged to convey an air flow through the test compartment 560 of the associated test slot 500, e.g., for convective cooling of a storage device 600 disposed within the test compartment 560. In this regard, the air mover 710 is arranged to draw an air flow in through air entrances 417 (FIGS. 7A and 7B) in the face plate 412 of the storage device transporter 400 and exhaust the air flow through the rectangular openings 135 in the back wall portion 118 (FIG. 11A) of the test slot carrier 110.

The air mover 710 can be electrically connected to the connection interface board 570 (FIG. 19) of the associated test slot 500 for communication with the test electronics 160. A suitable blower is available from Delta Electronics, Inc., model number BFB04512HHA.

The mounting plate 720 includes a plurality of projections 722. The projections 722 interface with the second grommets 134 in the body 112 (FIG. 10) and thereby help to support the air mover assemblies 700 within the body 112. More specifically, when assembled with the body 112, the projections 722 each sit within a hole 155 (FIG. 10) in a corresponding one of the second grommets 134. The second grommets 134 being formed of a mechanical vibration isolating material, inhibit the transmission of vibrations between the air mover assemblies 700 and the body 112.

Different ones of the test slot assemblies 120 can be configured for testing different types of storage devices (e.g., 69.85 mm×7-15 mm×100 mm disk drives, or solid state drives), and the different test slot assemblies 120 can be arranged in corresponding ones of the test slot carriers 110 such that each of the test slot carriers 110 supports associated test slot assemblies 120 that are configured to test a particular type of storage device. For example, in some embodiments, each of the individual test slot carriers 110 is configured to test either a 7 mm disk drive, 9.5 mm disk drives, 12 mm disk drives, or 15 mm disk drives. The test slot carriers 110 that are configured to test 9.5 mm disk drives can include a total of 14 test slot assemblies 120 (per carrier), each of the associate test slot assemblies 120 being configured to test a 9.5 mm disk drive. The test slot carriers 120 that are configured to test 12 mm disk drives can include a total of 12 test slot assemblies 120 (per carrier), each of the associate test slot assemblies 120 being configured to test a 12 mm disk drive. The test slot carriers 120 that are configured to test 15 mm disk drives can include a total of 7 test slot assemblies 120 (per carrier), each of the associate test slot assemblies 120 being configured to test a 15 mm disk drive.

The individual test slot assemblies 120 may have different dimensions depending on the particular type of storage device they are configured to test. However, regardless of which type of the test slot assemblies 120 the individual test slot carriers 110 support, all of the test slot carriers 110 can have the same overall dimensions and are configured to be interchangeable with each other among the many carrier receptacles 110 of the test racks 100 allowing for adaptation and/or customization of the testing system 10 based on testing needs.

In some embodiments, individual test slots 500 can be used to test different types of storage devices. In some cases, for example, test slots 500 that are configured to test taller storage devices can also be used to test shorter storage devices. As an example, a test slot 500 configured to test 15 mm disk drives may also be used to test 12 mm, 9.5 mm, and/or 7 mm disk drives.

A number of implementations have been described. Nevertheless, it will be understood that various modifications may be made without departing from the spirit and scope of the disclosure. For example, the protrusions on the test slots that interface with the isolators in the body could be embodied as protrusions on the body that interface with isolators on the test slots. Accordingly, other implementations are within the scope of the following claims.

What is claimed is:

1. An apparatus comprising:
a body;
a test slot assembly configured to receive and to support a storage device for testing;
at least one first vibration management element, disposed between the body and the test slot assembly and configured to disperse a first frequency vibrational energy; and
at least one second vibration management element, disposed between the body and the test slot assembly and configured to disperse a second frequency vibrational energy, the first frequency vibrational energy having a first frequency that is above a second frequency of the second frequency vibrational energy.

2. The apparatus of claim 1, wherein the test slot assembly comprises a protrusion, wherein the body comprises an aperture, and wherein one or more of the first vibration management element and the second vibration management element are configured to be disposed in the aperture and to substantially encircle the protrusion about a longitudinal axis of the protrusion.

3. The apparatus of claim 1, wherein the body comprises a protrusion, wherein the test slot assembly comprises an aperture, and wherein one or more of the first vibration management element and the second vibration management element are configured to be disposed in the aperture and to substantially encircle the protrusion about a longitudinal axis of the protrusion.

4. The apparatus of claim 1, wherein the first vibration management element comprises a dampening material selected from the group consisting of thermoplastics and thermosets.

5. The apparatus of claim 1, wherein the second vibration management element comprises a dampening material selected from the group consisting of thermoplastics and thermosets.

6. The apparatus of claim 1, wherein the first vibration management element has a durometer of more than 40 Shore A.

7. The apparatus of claim 1, wherein the second vibration management element has a durometer of less than 40 Shore A.

8. The apparatus of claim 7, wherein the second vibration management element has a durometer between 10 and 30 Shore 00.

9. The apparatus of claim 1, wherein the first vibration management element is configured to inhibit a rotation of the test slot assembly relative to the body.

10. The apparatus of claim 1, wherein the second vibration management element is substantially surrounded by the first vibration management element.

11. The apparatus of claim 10, wherein the first vibration management element and the second vibration management element form an isolator.

12. The apparatus of claim 11, wherein the isolator comprises a grommet.

13. The apparatus of claim 1, wherein the second vibration management element is further configured to continuously inhibit the transmission of frequency vibrational energy below the first frequency.

14. The apparatus of claim 1, wherein the frequency vibrational energy falls within the range of 0.05 Hz to 50 Hz.

15. The apparatus of claim 1, wherein the second vibration management element comprises a gel.

16. The test slot carrier of claim 15, wherein the gel comprises a styrene gel.

17. The test slot carrier of claim 15, wherein the gel comprises a urethane gel.
